(19) United States
(12) Patent Application Publication
(10) Pub. No.: US 2024/0307151 A1
(43) Pub. Date: Sep. 19, 2024

(54) CERAMIC PROCESSING AND DESIGN FOR THE DIRECT MANUFACTURE OF CUSTOMIZED LABIAL AND LINGUAL ORTHODONTIC CLEAR ALIGNER ATTACHMENTS

(71) Applicant: LightForce Orthodontics, Inc., Burlington, MA (US)

(72) Inventors: Alfred Charles Griffin, III, Lynnfield, MA (US); Kelsey A. Fafara, Watertown, MA (US)

(73) Assignee: LightForce Orthodontics, Inc., Burlington, MA (US)

(21) Appl. No.: 18/543,098

(22) Filed: Dec. 18, 2023

Related U.S. Application Data
(63) Continuation of application No. 16/437,728, filed on Jun. 11, 2019, now Pat. No. 11,890,157.
(60) Provisional application No. 62/683,816, filed on Jun. 12, 2018.

(51) Int. Cl. A61C 7/00; A61C 7/08; A61C 7/14; A61C 7/16; A61C 7/20; A61C 7/36; A61C 13/00; B22F 10/10; B22F 10/12; B22F 10/28; B22F 10/80; B22F 12/42; B29C 64/393; B29K 33/00; B29K 509/02; B29L 31/00; B33Y 10/00; B33Y 50/02; B33Y 70/00; B33Y 80/00; G05B 19/4099

(52) U.S. Cl. CPC A61C 7/002; A61C 7/08; A61C 13/0004; A61C 13/0013; B29C 64/393; B33Y 50/02; B33Y 70/00; G05B 19/4099; A61C 7/145; A61C 7/148; A61C 7/16; A61C 7/20; A61C 7/36; A61C 13/0019; B22F 10/10; B22F 10/12; B22F 10/28; B22F 10/80; B22F 12/42; B29K 2033/08; B29K 2509/02; B29L 2031/7532; B33Y 10/00; B33Y 80/00; G05B 2219/35134; G05B 2219/49007

(57) ABSTRACT

A method of manufacturing pre-formed, customized, ceramic, labial/lingual orthodontic clear aligner attachments (CCAA) by additive manufacturing (AM) may comprise measuring dentition data of a profile of teeth of a patient, based on the dentition data, creating a three dimensional computer-assisted design (3D CAD) model of the patient's teeth using reverse engineering, and saving the 3D CAD model, designing a 3D CAD structure model for one or more CCAA on various parts of each tooth, importing data related to the 3D CAD CCAA structure model into an AM machine, directly producing the CCAA in the ceramic slurry-based AM machine by layer manufacturing, enabling the provider to deliver patient-specific CCAA's by an indirect bonding method to the patient's teeth to improve the efficacy and retention of the clear aligners.

### CROSS-REFERENCE TO RELATED APPLICATIONS

This application claims the benefit of U.S. Provisional Application No. 62/683,816, filed Jun. 12, 2018, the contents of which are hereby incorporated by reference herein in their entirety.

### BACKGROUND OF THE INVENTION

### 1. Field of the Invention

An embodiment of present invention relates generally to the manufacturing of ceramic labial/lingual orthodontic clear aligner attachments (CCAAs) that create added retention for clear aligners used for straightening the teeth and correcting malocclusion. More specifically, an embodiment of the invention relates to the methodology of direct manufacture of customized ceramic labial/lingual orthodontic clear aligner attachments by using a ceramic slurry-based additive manufacturing (AM) technology.

### 2. Description of the Related Art

A need arises for more efficient and accurate techniques for creating custom lingual and labial ceramic clear aligner attachments, and more aesthetic labial Clear Aligner Attachments (CAAs). Currently, CAAs for tray aligner treatment are fabricated from a variety of filled and unfilled, shaded, or translucent, bonding materials (such as dental composite) similar to that used to attach conventional orthodontic CAAs to teeth. They are formed by inserting this bonding material into a pre-designed and fabricated aligner-like tray that has the attachment mold included in its shape, and then using a bonding system similar to orthodontic CAA bonding to adhere the CAA to the teeth. This results in excess bonding material, or “flash” that then needs to be ground off with a drill in order to assure a proper fit of the subsequent orthodontic aligner trays. During the process of flash removal, often the attachment itself is inadvertently contacted by the drill bit and its shape is mistakenly altered, resulting in an unintentional CAA shape that doesn't conform as well with the aligner trays.

During the everyday insertion and removal of the aligner trays, the tray abrades the attachment in such a way as to actually alter the CAA's shape. Often, these attachments must be removed and replaced during aligner refinement procedures because of the significance of the wear on the CAA from this insertion and removal abrasion.

During the removal of CAAs made from bonding material, a high speed drill is utilized to grind off the CAA and remove any residual flash present on the tooth surface. This results in enamel also being removed from the tooth surface, as it is not within the technical ability of the dentist to adequately discern the boundary between the layer of bonding material and the enamel surface.

There is a need for more efficient and accurate techniques for creating custom lingual and labial ceramic clear aligner attachments' that are more easily and accurately placed and more durable during active orthodontic treatment. After treatment, a more effective removal system of these attachments would include less polishing of the tooth surface with the unwanted side effect of damage to the enamel of the tooth.

### SUMMARY OF THE INVENTION

The proposed invention utilizes Ceramic CAAs (CCAAs) that may be fabricated by ceramic slurry-based Additive Manufacturing (AM) and may be bonded to the tooth with an unfilled/filled bonding resin material already in use in dentistry. These CCAAs will be placed in an indirect transfer tray and then bonded to the teeth surfaces utilizing the unfilled or partially filled bonding resin.

An embodiment of the present devices and methods may be used to solve problems occurring in the current methods of creating resin-based CCAAs. For example, in one embodiment, it may provide a direct manufacturing method of customized lingual/labial CCAAs by utilizing any number of ceramic slurry-based AM technologies, examples of which may include digital light processing (DLP), laser photopolymerization stereolithography, jet printing (including particle jetting, nanoparticle jetting), layer slurry depositioning (LSD), or laser-induced slip casting. A slurry is defined as inorganic particles dispersed in a liquid, and may be photopolymerizable or may polymerize by other mechanisms. Likewise, similar methods may be used to create metal CCAAs wherein the inorganic materials in the slurry are metal. Examples of items that may be produced include customized labial/lingual CCAAs according to individual clear aligner (CA) retention needs on individual teeth, which may have direct tooth-matching retentive features designed into the CCAA base.

The present devices and methods may provide several advantages over the current methodology. 1) The removal of excessive bonding material will be significantly minimized—less filled resins may be used, which have a much thinner layer conformation than filled resins. 2) CCAAs will also result in a much more accurate and precise shape versus classical resin-based CCAAs, as variances in the thickness of the bonding material will not be able to result in variances in the shape of the CCAA. 3) The CCAA will not be able to be inadvertently damaged or altered in its shape by the post-placement flash polishing procedure because there will be less flash and the ceramic material of which the OA is fabricated will be resistant to indentation by accidental contact with the drill during the polishing/flash removal process. The CCAA will be more exact in its shape because it will be formed first, by Additive Manufacturing (AM), and then may be adhered with a thinner adhesive. This results in less variability of shape than the current procedures where the technique of placement can greatly vary the shape of the OA. 5) Most importantly, the OA will not be susceptible to deformation in shape due to abrasion from constant insertion and removal of the aligner trays because the ceramic OA is much more resistant to abrasion.

For example, in an embodiment, a method of manufacturing pre-formed, customized, ceramic, labial/lingual orthodontic clear aligner attachments (CCAA) by additive manufacturing (AM) may comprise measuring dentition data of a profile of teeth of a patient, based on the dentition data, creating a three dimensional computer-assisted design (3D CAD) model of the patient's teeth using reverse engineering, and saving the 3D CAD model, designing a 3D CAD structure model for one or more CCAA on various parts of each tooth, importing data related to the 3D CAD CCAA structure model into an AM machine, directly producing the CCAA in the ceramic slurry-based AM machine by layer manufacturing to form a patient-specific CCAA by an indirect bonding method, the patient-specific CCAA adapted to the patient's teeth.

In embodiments, two CCAAs may comprise mirrored structures adapted to produce torque movement. An angle of a working edge of each CCAA may be adapted to provide the desired torque for a particular tooth structure. A working edge for aligner retention may have an angle relative to the tooth structure of 90 degrees plus or minus and angle of the desired torque. A notch in the attachment edge may be adapted to aid in debonding with pliers such as ligature-cutting pliers. The CCAA may comprise a button adapted to be used to rotate the tooth through force applied by the aligner. A force-rotational relationship may be dependent on a thickness and angulation of the CCAA button. The CCAA may have a fracture groove in a middle vertical third of the bracket and is a adapted to provide predictable CCAA breakage. The fracture groove may include a weakened area including a tooth curved depression in the bracket base in an occlusal-gingival direction. The fracture groove may match a contour of a tooth for that portion of the bracket positioning. The fracture groove may be constant in depth from the tooth surface. The fracture groove may have a depth of 0.10 mm to 1.2 mm, inclusive. The fracture groove may vary in depth from the tooth surface. The fracture groove may have a variance in depth of 1-50%, inclusive, of a distance from the tooth surface to a deepest part of fracture groove. The CCAA may have a positive indented or negative indented nomenclature in at least one side of the CCAA to denote which tooth and area of the tooth to which the CCAA is meant to be bonded. The nomenclature may include a tooth number. The tooth number may be in Palmer notation. The CCAA may have an attachment tube with a channel comprising a slot that does not require ligation adapted to be placed on a tooth for to accept a wire to move the tooth with or without a clear aligner. The channel may pass mesial-distal and may be consistent in cross-sectional measurement. The channel has a circular, rectangular, or square cross-section. The channels with square and rectangular cross-sections may have rounded corners of a selected radius. The method may further comprise placing two CCAAs via indirect bonding on a same tooth, wherein each CCAA has a channel, the CCAAs are separate, and have their channels aligned so that a wire passes through the channels on both CCAAs without deflection. An average cross-sectional area of the tube may be not greater than 0.50 mm2.

### BRIEF DESCRIPTION OF THE DRAWINGS

FIG. 1 is an exemplary flow diagram of an embodiment of a process for direct manufacturing of lingual or labial orthodontic attachments or attachment brackets.

FIG. 2 illustrates an example of an orthodontic attachment.

FIG. 3 is an exemplary illustration of an embodiment of an orthodontic attachment.

FIG. 4 illustrates an example of a single attachment on a lower premolar molar tooth.

FIG. 5 is an exemplary block diagram of a computer system in which embodiments of the present systems and method may be implemented.

FIGS. 6a, 6b, and 6c are exemplary illustrations of an embodiment of a CCAA with fracture groove.

FIGS. 7a and 7b are exemplary illustrations of an embodiment of a CCAA with fracture groove.

FIGS. 8a and 8b are exemplary illustrations of an embodiment of an orthodontic attachment and retentive features.

FIGS. 9a and 9b illustrate a base view of an example single attachment with and without retentive structures.

FIG. 10 is an exemplary illustration of an embodiment of an orthodontic attachment.

FIGS. 11a, 11b, and 11c are exemplary illustrations of an embodiment of an indirect bonding jig for orthodontic attachments.

FIGS. 12a and 12b are exemplary illustrations of an embodiment of an orthodontic attachment bracket.

FIG. 13 is an exemplary illustration of an embodiment of an orthodontic attachment.

FIG. 14 is an exemplary illustration of an embodiment of orthodontic attachments.

### DETAILED DESCRIPTION OF THE INVENTION

An embodiment of the present invention provides improved techniques for creating custom lingual or labial CCAAs.

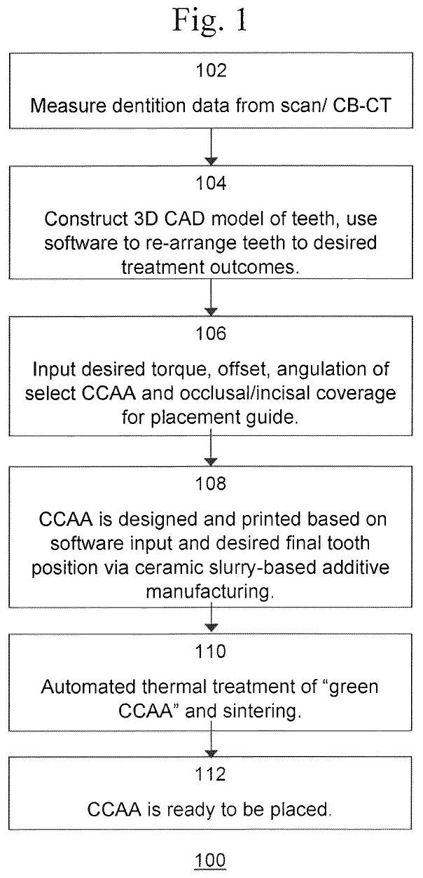

An exemplary flowchart of an embodiment a direct manufacturing process 100 of lingual or labial orthodontic CCAAs by digital light processing is shown in FIG. 1. The process begins with 102, in which dentition data is measured and the parameters of the tooth profile are analyzed. For example, such measurement may use CT layer scanning a non-contact 3D scanner or an intra-oral scanner directly on the patient's teeth, or may use 3D readings on a teeth model previously cast or 3D printed using a coordinate measuring machine, a laser scanner, or a structured light digitizers. The scanning accuracy of such techniques is typically less than 0.02 mm. A manufacturing accuracy in the z-axis of the ceramic slurry-based AM machine may be from 5 to about 60 μm, and wherein the accuracy may be achieved by using a between layer additive error compensation method that predicts an amount of polymerization shrinkage.

In 104, based on the given dentition data, a 3D CAD model of the measured teeth is constructed based on the dentition data and saved in the computer in a typical file format, such as the .stl file format. The exterior structure of teeth is complicated, usually including irregular curves. The software may then be used to re-arrange the teeth in the model to the desired treatment outcomes that may be based on the long-axis of a tooth.

In 106, additional information, such as the desired shape and tooth location of the CCAAs are determined.

In 108, the CCAA is designed by the software or chosen from a list of options by the clinician based on the input 3D CAD model of the measured teeth, the model of the desired treatment outcomes, and the anticipated limitations of the CA and its ability to track on the teeth throughout treatment. The output of the design process may be a 3D CAD model. Such a 3D CAD model may be designed for a single lingual/labial CCAA structure, including the indirect bonding (IDB) tray.

3D CAD CCAA structure models of labial or lingual CCAAs may be designed by computer according to the orthodontic requirements, CA material considerations, and teeth morphology.

3D CAD CCAA structure models are processed to generate manufacturing control data for use by the production equipment. For example, where ceramic slurry-based AM equipment is used to produce the CCAAs, the software slices the 3D CAD CCAA structure models to separate it into thin layers and get the horizontal section model for each layer. Based on this section model, the ceramic slurry-based AM equipment can directly produce CCAAs, ensuring the shape of each layer is consistent to the 3D CAD structure data. For example, the thickness of such layers may be about 20 μm to about 50 μm (micrometers or microns) with a manufacturing accuracy of about 5 μm to about 60 μm by using between-layer additive error compensation.

Returning to 108 of FIG. 1, the 3D CAD CCAA structure model is transmitted to or imported into a ceramic slurry-based AM machine, such as a DLP machine and the ceramic CCAAs are produced. In the case of AM DLP or another ceramic slurry-based AM procedure, the CCAA may be produced by digital light processing directly.

Digital light processing (DLP) is another 3D additive manufacturing (AM) process that works by stacking layers of a photocurable resin with an Aluminum Oxide (Al₂O₃) or Zirconium Oxide (ZrO₂) solid loading, and followed by a thermal debinding and sintering step. The higher resolution of this process is made possible by the LED light's digital mirror device (DMD) chip and optics used. Lithography-based ceramic manufacturing (LCM) has improved this process making it more accurate with higher resolution (40 μm) and rigidity. The new LCM process involves the selective curing of a photosensitive resin containing homogenously dispersed oxide or glass ceramic particles that can be fabricated at very high resolution due to imaging systems which enable the transfer of layer information by means of ever-improving LED technology.

In 110, post-processing may then be applied. For example, a thermal treatment (for binder burnout) and a sintering process may be applied to achieve optimal or improved ceramic density. For example, the debinding and sintering phase may include removing the green CCAA from the device, exposing the blank to a furnace to decompose the polymerized binder (debinding), and sintering of the ceramic material.

Examples of raw materials of the CCAAs may include powder of high strength oxides, nitrides and carbides ceramics including but not limited to: Aluminum Oxide (Al₂O₃), Zirconium Oxide (ZrO2), Alumina toughened Zirconia (ATZ), Zirconia-toughened alumina (ZTA), Lithiumdisilicate, Leucitesilicate, Nitrides (e.g. SiN4), and mono- or polycrystalline ceramic. The base of CCAA may be adhered to the tooth surface and the CCAA surface may be matched to matching indentations within the CA. According to requirements of mechanical properties, different composition of material may be required for the layers during the DLP manufacturing process. After being built up, the CCAAs may have a gradient and better performance.

Further, the CCAA surface may be processed based on clinical demand.

In 112, the CCAA is ready to be placed.

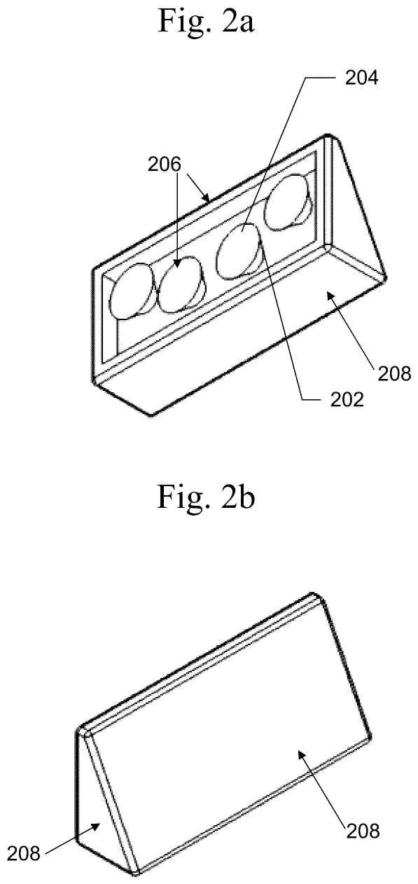

FIG. 2 depicts an orthodontic attachment, such as a CCAA, where the base of the attachment may be the surface that contacts the tooth and the face of the attachment may include any surface that contacts the aligner.

Typically, the thickness 202 of the CCAA pad 204 may extend less than 2.0 mm for lingual CCAAs and less than 2.5 for labial CCAAs from the surface of the tooth, with a labial and lingual minimum extension of 0.25 mm. The CCAA pad 204 may be adhered to the tooth surface with well-known dental adhesives that may be unfilled dental resins or partially filled dental resins. Depending upon the manufacturing process used, different ceramics or composition of powder may be required for the layers. For example, if a selective laser melting manufacturing process is used, an LED light source may be used for the selective curing of a photosensitive resin containing the oxide or glass ceramic particles. Different layers may use different ceramics or compositions of powder.

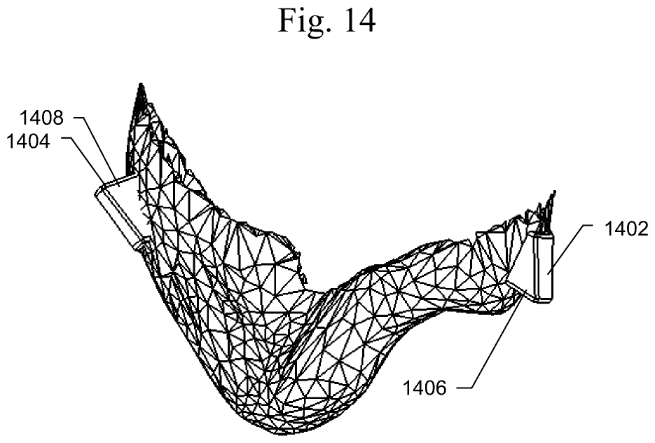

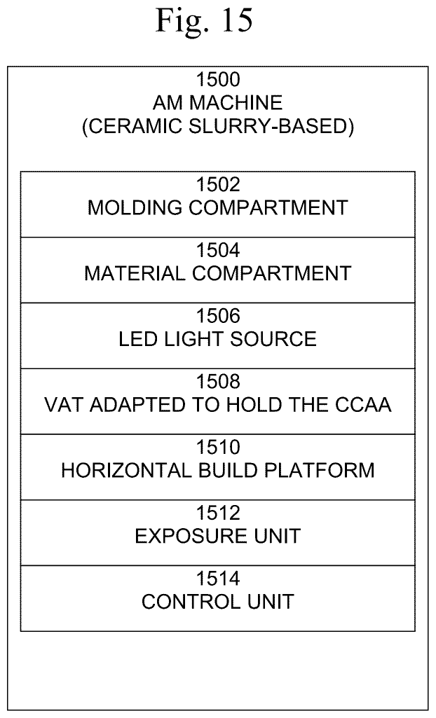

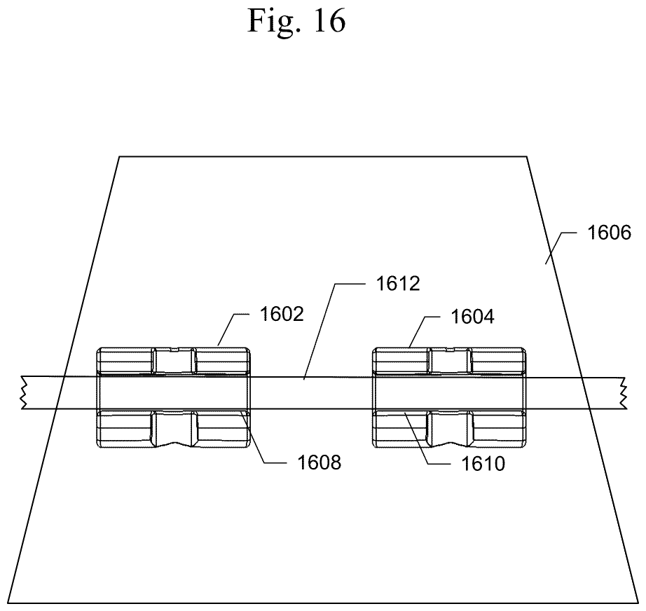

The CCAA pad 204, which holds or connects the CCAA to the tooth surface, may be designed specifically according to the tooth surface profile, instead of a generalized gridding pattern. The customized CCAAs can meet individual case demand, such as increased vertical tracking for upper lateral incisors or for lower premolars to level the curve of Spee or reduce overbite. For example, as shown in FIG. 14, the curve on tooth surface and the designed CCAA, the tooth side of the CCAA (CCAA pad) is matched to the lingual or labial surface of the tooth, for example for lingual CCAA 1402 and labial CCAA 1404. FIG. 14 depicts two orthodontic attachments 1402, 1404 bonded to a tooth where the opposing directions of the attachments aids in creating lingual crown torque tooth and where flipping the axis of the attachments would result in labial crown torque. The specific angle of the retentive edge 1406, 1408 and locations of the attachments optimize the torqueing moment on the tooth. In this example, orthodontic attachment 1402 has −8 degrees of torque and orthodontic attachment 1404 has +8 degrees of torque. The orthodontic aligner may place a force on each retentive end to facilitate the motion. The trapezoidal shape of the aligner may ensure one edge is always acting like a retentive feature to hold the aligner to the arch.

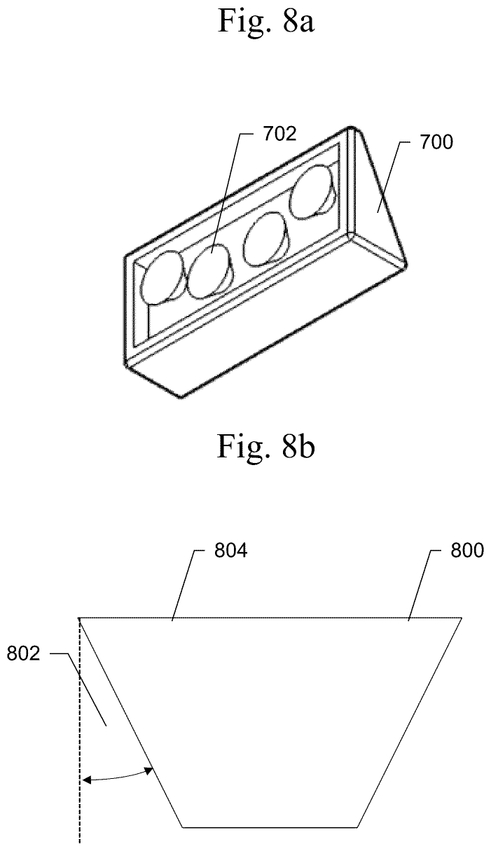

FIG. 8 depicts an example of retentive structures 702 designed into the base of attachment 700 base. These retentive structures 702 may be of any shape that is a three-dimensional FIG. 800 with a positive draft angle 802 greater than 0, as shown in FIG. 8b. Other examples of retentive structures other than semi-lunar cones may include full-circles, squares, rectangles, any variety of retentive lattices or meshes—all shapes that at some point would have a positive draft angle and would therefore be more efficiently manufactured via 3DP vs injection molding.

The neutral plane of the draft may be oriented towards the tooth structure and may be flat or itself contoured to the shape of the tooth surface to which it is meant to be bonded. While any degree of retention would achieve the intended retentive interaction with bonding cement, a range of designed draft angles may be utilized to compensate for the limitations of a specific 3D printing process.

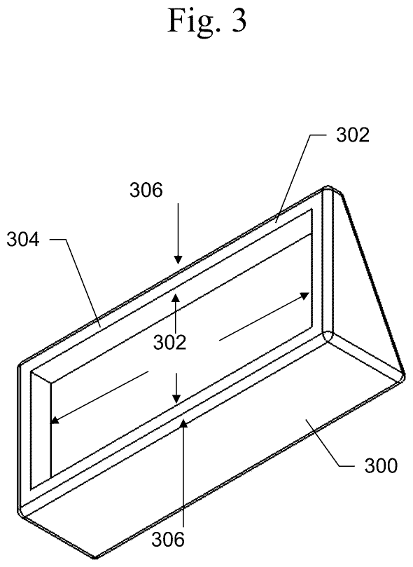

FIG. 3 depicts a thin fracture wall 302 around the attachment 300 base, which has a thickness 304 of about 10 to about 150 μm, inclusive. Bonding cement may be inserted into the cavity formed by the thin fracture wall. The wall thickness may consistent around all edges of the attachment enabling a normal force to be applied in any direction (mesial-distal, occlusal-gingival, or to any opposing corners). The continuity of the wall around the entire attachment 300 may enable predictable fracture of the wall via pliers in any direction, enabling debonding of the attachment 300 through a combination of tensile and peeling forces.

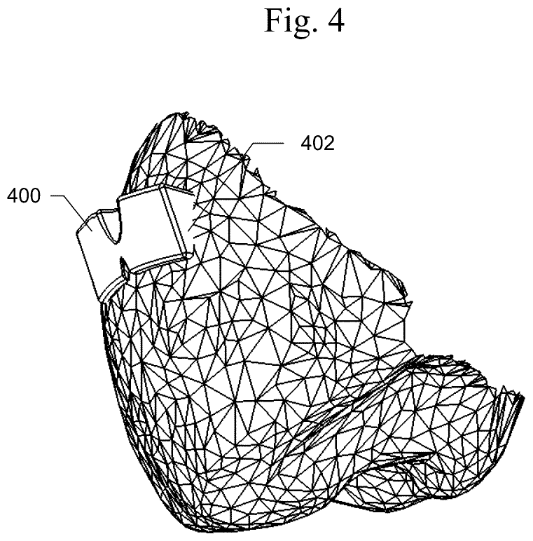

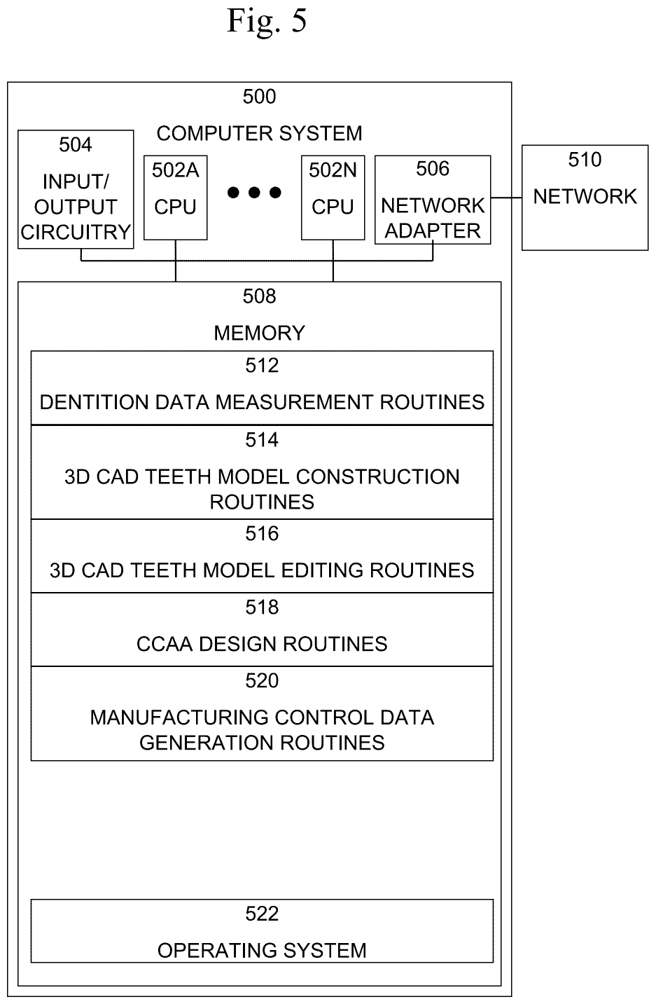

FIG. 4 depicts an attachment 400 with its base 402 contoured to the shape of the tooth. The contouring may match the desired position of the attachment on the tooth. Any changes in the attachment's positioning would reflect changes in the contouring. The base and the face are contoured to the tooth.

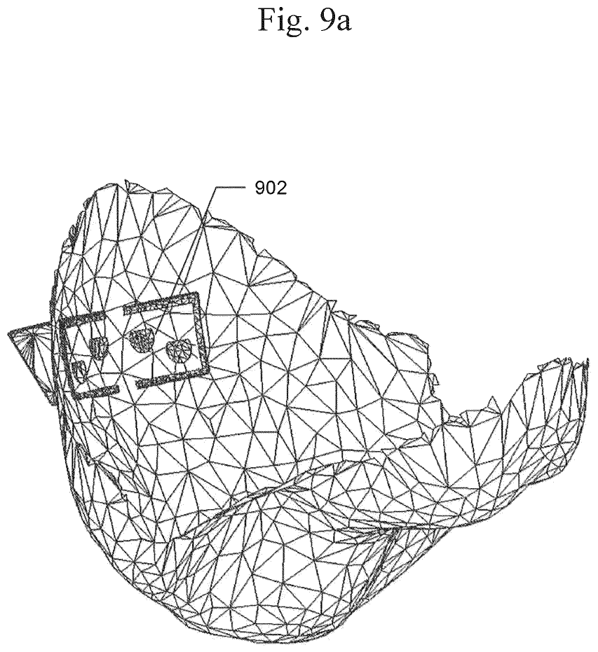

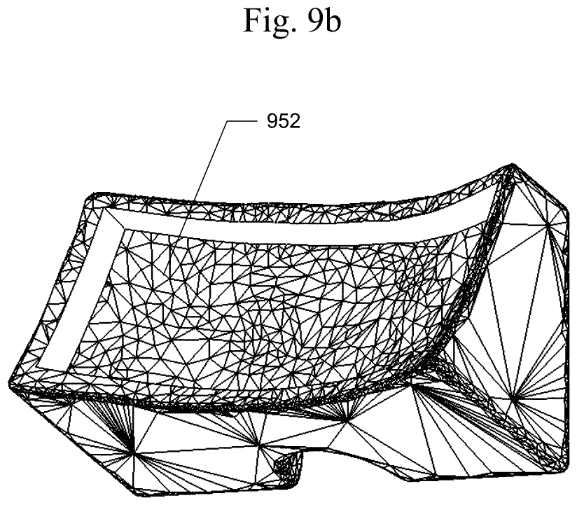

FIG. 9a depicts the retentive structures, such as 902, contoured to the tooth surface looking from the inside of a tooth 3D vector (.stl) shell. Each structure may be contoured to fit its corresponding area of tooth surface within the attachment position. The attachment base cavity 952 shown in FIG. 9b may also be contoured to ensure each retentive structure maintains its dimensions and all structures have a similar depth.

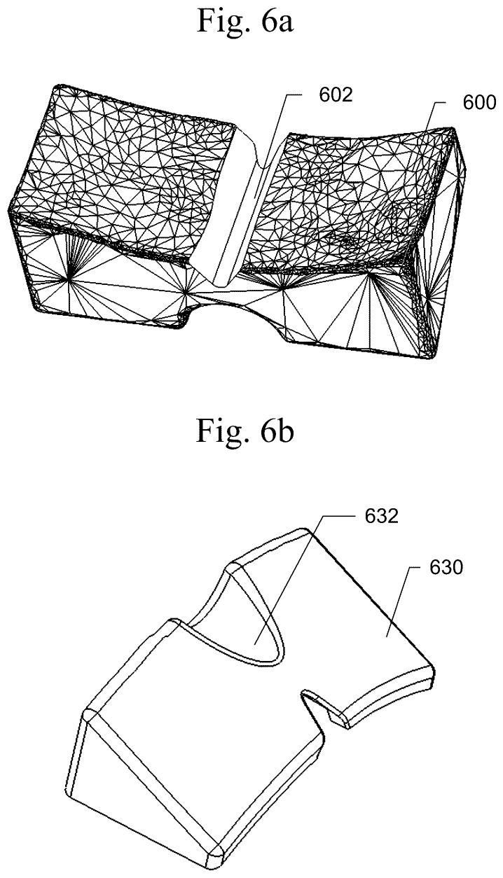

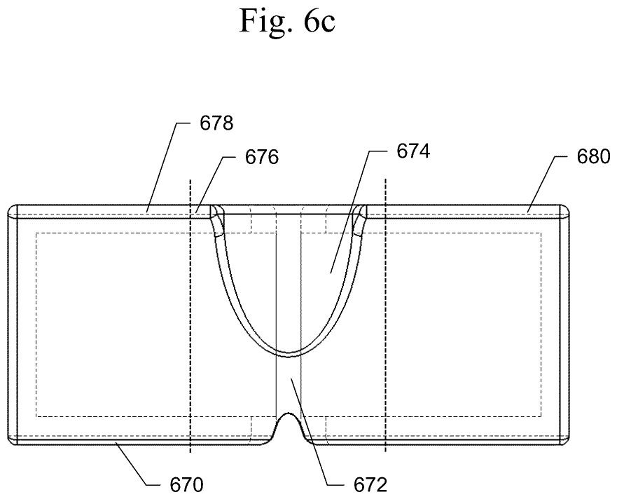

FIG. 6a depicts an example of a fracture groove 602 within the middle vertical third of a ceramic attachment 600 viewed from the attachment's base. FIG. 6b depicts an example of an auxiliary fracture groove 632 within the middle vertical third of a ceramic attachment 630 viewed from the attachment's face. FIG. 6c. depicts the attachment 670 split into thirds with the fracture groove 672 and auxiliary fracture groove 674 within the middle third 676 of the attachment, between the mesial third 678 and distal third 680, viewed from the attachment's face. The respective ratios for the fracture and auxiliary fracture groove distances from the mesial and distal edges may be variable.

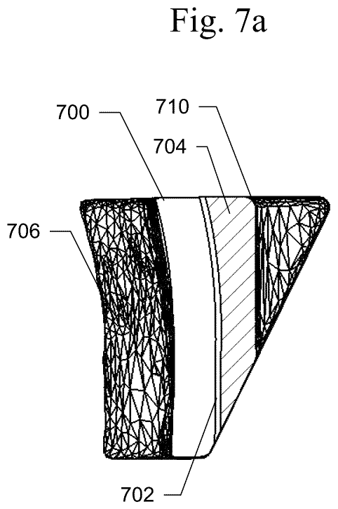

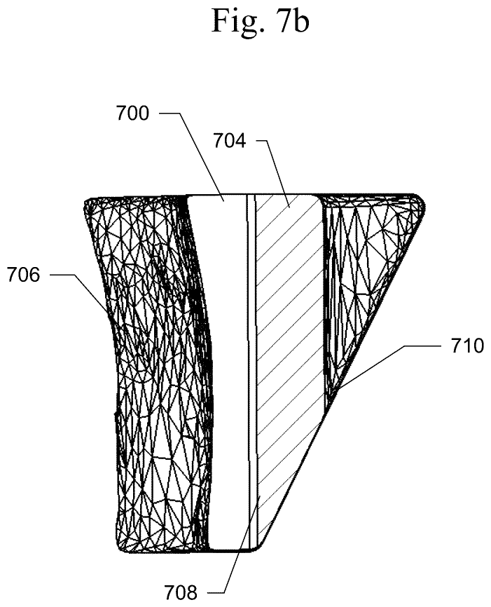

A side view of an exemplary printed CCAA 700 is shown in FIGS. 7a and 7b. The pad 706 of the CCAA may highly match the tooth surface and maximize the tooth contact surface. This may allow for more accurate CCAA placement by the clinician and better bond approximation to the tooth. FIG. 7a depicts the weakened area consisting of a tooth curved depression 702 (groove) in the attachment base running vertically (occlusal-gingival) within the middle third of the attachment, as in FIGS. 6a and 6c. The attachment area 704 between the fracture groove and auxiliary fracture groove features may form the attachment's weakened area.

Finite-element analysis has revealed that mesial-distal forces on the sides of the attachment result in a concentration of forces in the middle third of the attachment base. The groove is defined as the area of removed material from where forces would have been most concentrated. The addition of this “groove” lowers the forces required to predictably create an attachment fracture down the middle vertical third of the attachment, which aids in debonding the ceramic attachment from the tooth. The weakened area, and the fracture force may be optimized by adjusting the dimensions of the fracture groove and/or the auxiliary fracture groove.

As shown in FIG. 7a, groove 702 may be consistent in depth from the tooth surface, matching the contour of the tooth. Likewise, as shown in FIG. 7b, groove 708 may be variable in distance from the tooth surface. In either embodiments, the groove depth may be a nominal value for all attachments or may vary based on the attachment width. In instances where the groove is a nominal value, the groove depth may be in a range of 0.10 mm to 1.0 mm. In instances where the groove depth is variable, it may have a range of 1-50% of the width.

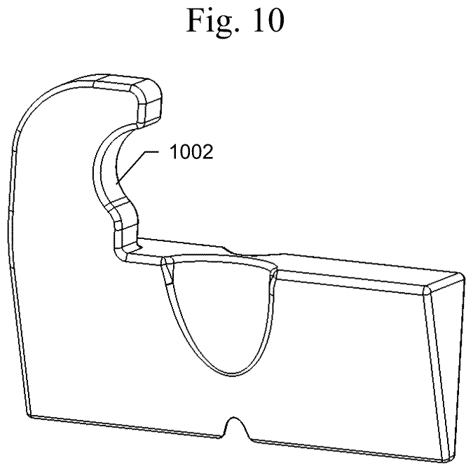

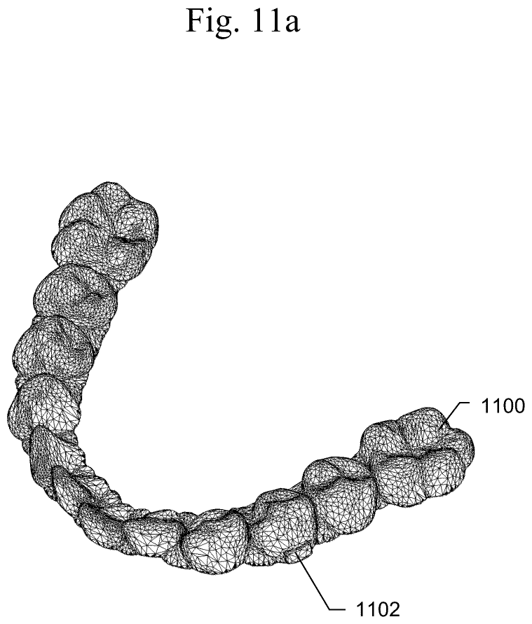

CCAA 600 may further include an attachment such as a hook 1002, shown in FIG. 10 that provides the capability to use additional delivery systems such as elastomers, springs or other attachments that create vectors of force. The example shown in FIG. 10 depicts an orthodontic attachment with a distal gingival hook. The hook may be used for any form of orthodontic elastics to aid in the treatment of malocclusion. In a number of embodiments, these features may be manufactured as one piece, protruding from any predesigned area to create the proper force vectors desired, and no machining of the features is required to produce a suitable CCAA.

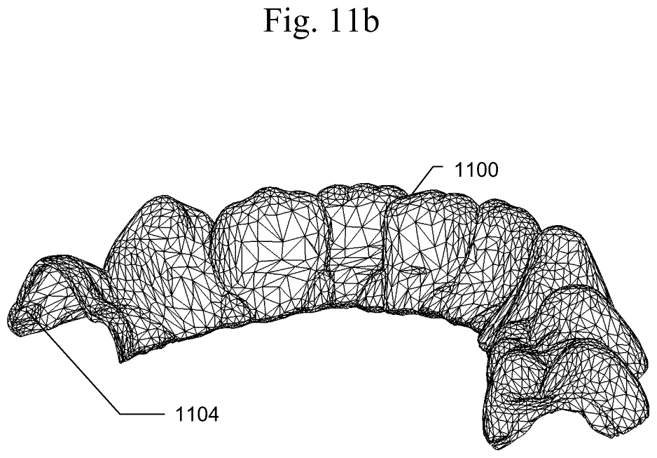

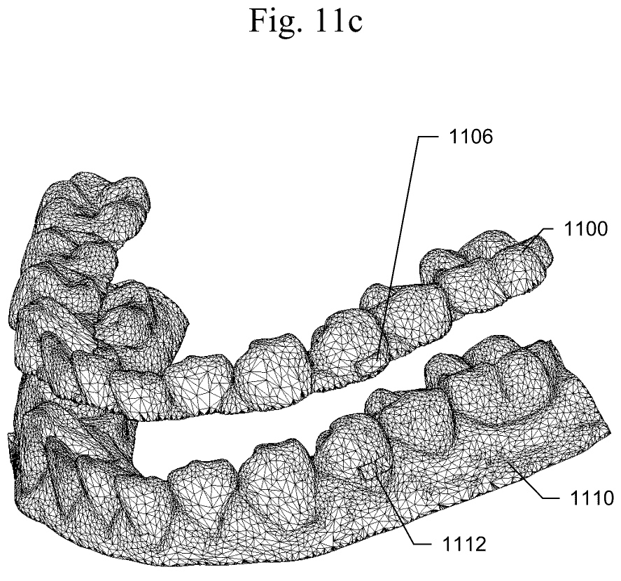

FIGS. 11a, 11b, 11c depict an exemplary orthodontic aligner 1100 that accommodates an orthodontic attachment 1102, 1104, 1106 with any given shape. Only one exemplary shape is depicted in this image, but the present devices and methods are applicable to any shape. The attachment indentation fits over and completely encases the attachment to aid in movement. The aligner may be easily pulled over the attachment for removal.

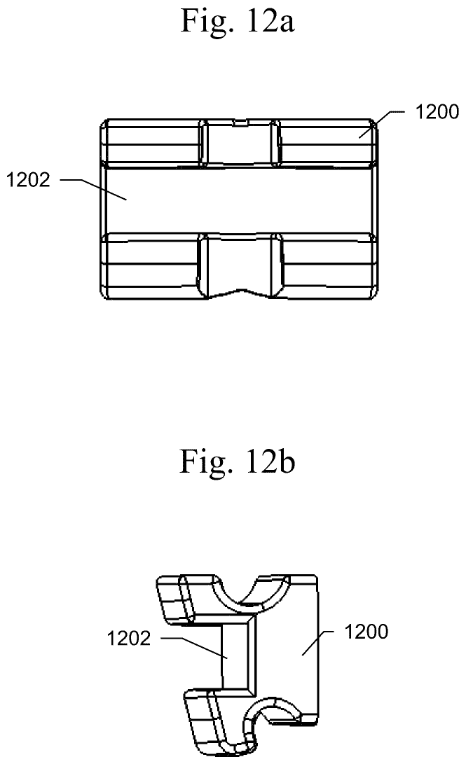

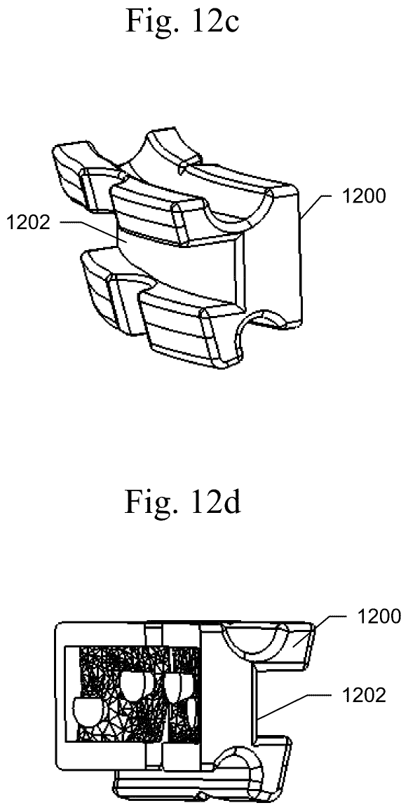

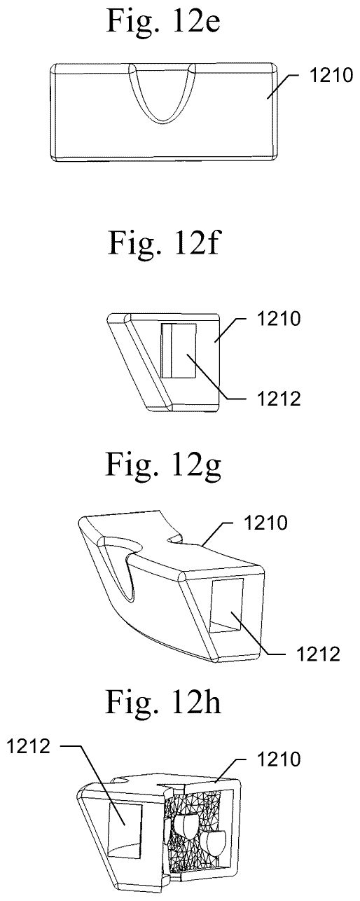

FIGS. 12a and 12b depict exemplary orthodontic attachments that may be used in combination aligner-bracket treatment. FIG. 12a depicts several views of an exemplary attachment 1200 with a curved slot 1202 that can accommodate a standard orthodontic wire. This example shows a ribbon wire configuration, whereby the archwire is longer vertically than horizontally. FIG. 12b depicts several views of an exemplary attachment tube 120 that may be placed on teeth for the purposes of accepting a wire to move teeth with or without a clear aligner. The channel 1212 may pass mesial-distal and may be consistent in cross-sectional measurement, which may be of a circular, rectangular (in this example) or square in cross-sectional design, with square and rectangular cross-sections having slightly rounded corners of a chosen radius. Regardless of the shape, in embodiments, the average cross-section of the tube may be no greater than 0.50 mm².

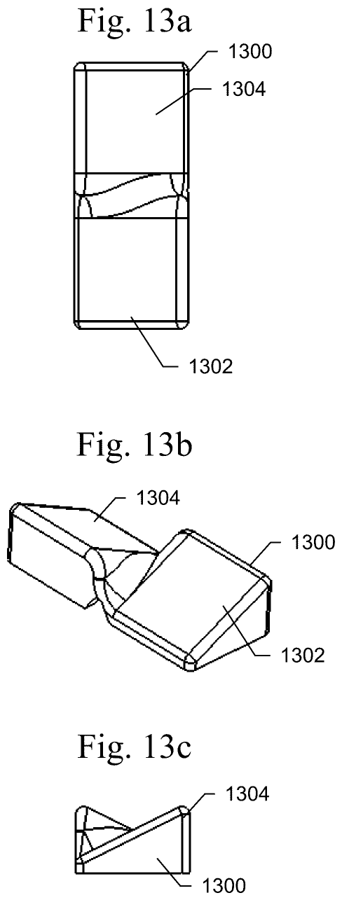

FIG. 13 depicts several views of an exemplary orthodontic attachment 1300 that may be used to aid in tipping, torqueing, or rotating the tooth. Half of the attachment retaining edge 1302 is on one side while the other half 1304 is on the opposing side. The location and angle the attachment is placed on the tooth may determine the force placed on each retaining edge. This action may not only aid in tooth movement but may remain an active measure in retaining the aligner on the arch.

Using the ceramic slurry-based AM technique can turn the designed model into a ceramic product rapidly. The CCAA manufacturing involves few steps and can be done on site, saving time and cost.

The described techniques may be used to manufacture CCAAs from various Oxide ceramics and light-curable materials such as Aluminum Oxide (Al₂O₃) and Zirconium Oxide (ZrO₂).

Many patients desire a CCAA that matches the color of the tooth to which the CCAA is attached. As another example, embodiments of the present invention may provide the capability to produce translucent CCAAs, which may provide still improved appearance. Additionally, embodiments of the present invention may provide the capability to produce CCAAs in a shade closely matched to the patient's tooth shades, which may be the same shade or matched to individual teeth as the tooth shades vary.

The described techniques may be made cost-effective to the point where an individual orthodontic practice could purchase the required equipment and software.

Ceramic slurry-based AM has many advantages for orthodontic CCAA fabrication over selective laser sintering/melting (SLM) which uses thermal energy, and 3-D printing (3DP) systems that use a binder and polymer-derived ceramics (PDCs). For example, ceramic slurry-based AM may provide higher surface quality, better object resolution, and improved mechanical properties. PDCs structured using light in a stereolithographic or mask exposure process may also be used as a ceramic AM method for CCAA fabrication.

Custom lingual CCAAs may be fabricated by this method, which may receive a pro-bent customized archwire as described by US 2007/0015104 A1. Custom labial CCAAs may also receive pre-bent wires.

The procedure for the layering additive manufacturing (AM) methodology of the labial/lingual orthodontic CCAAs by ceramic slurry-based Amiss as follows.

An example of ceramic slurry-based AM is the lithography-based digital light processing (DLP) technique described in U.S. Pat. No. 8,623,264 B2, which is incorporated herein by reference, but may be briefly summarized as follows: a light-polymerizable material, the material being located in at least one trough, having a particularly light-transmissive, horizontal bottom, is polymerized by illumination on at least one horizontal platform, the platform having a pre-specified geometry and projecting into a trough, in an illumination field, wherein the platform is displaced vertically to form a subsequent layer, light-polymerizable material is then added to the most recently formed layer, and repetition of the foregoing steps leads to the layered construction of the orthodontic CCAA in the desired prescription/mold, which arises from the succession of layer geometries determined from the CAD software. The trough can be shifted horizontally to a supply position, and the supply device brings light-polymerizable material at least to an illumination field of the trough bottom, before the at least one trough is shifted to an illumination position in which the illumination field is located below the platform and above the illumination unit, and illumination is carried out, creating a “green CCAA”.

The light-polymerizable material or photo-reactive suspension (slurry) can be prepared based on commercially available di- and mono-functional methacrylates. An example material might be a slurry blend of 0.01-0.025 wt % of a highly reactive photoinitiator, 0.05-6 wt % a dispersant, an absorber, and 2-20 wt % of a non-reactive diluent. A solid loading of high strength Oxide ceramics such as Aluminum Oxide (Al₂O₃) and Zirconium Oxide (ZrO₂) powder can be used, but this process may extend to other ceramic materials.

An exemplary block diagram of a computer system 700, in which the processes shown above may be implemented, is shown in FIG. 7. Computer system 700 is typically a programmed general-purpose computer system, such as a personal computer, workstation, server system, and minicomputer or mainframe computer. Computer system 700 includes one or more processors (CPUs) 702A-702N, input/output circuitry 704, network adapter 706, and memory 708. CPUs 702A-702N execute program instructions in order to carry out the functions of embodiments of the present invention. Typically, CPUs 702A-702N are one or more microprocessors, such as an INTEL PENTIUM® processor. FIG. 7 illustrates an embodiment in which computer system 700 is implemented as a single multi-processor computer system, in which multiple processors 702A-702N share system resources, such as memory 708, input/output circuitry 704, and network adapter 706. However, the present invention also contemplates embodiments in which computer system 700 is implemented as a plurality of networked computer systems, which may be single-processor computer systems, multi-processor computer systems, or a mix thereof.

Input/output circuitry 704 provides the capability to input data to, or output data from, computer system 700. For example, input/output circuitry may include input devices, such as keyboards, mice, touchpads, trackballs, scanners, etc., output devices, such as video adapters, monitors, printers, etc., and input/output devices, such as, modems, etc. Network adapter 706 interfaces device 700 with a network 710. Network 710 may be any public or proprietary LAN or WAN, including, but not limited to the Internet.

Memory 708 stores program instructions that are executed by, and data that are used and processed by, CPU 702 to perform the functions of computer system 700. Memory 708 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCST) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 708 varies depending upon the function that computer system 700 is programmed to perform. In the example shown in FIG. 7, memory contents that may be included in a system in which a content analysis platform is implemented are shown. However, one of skill in the art would recognize that these functions, along with the memory contents related to those functions, may be included on one system, or may be distributed among a plurality of systems, based on well-known engineering considerations. Embodiments of the present invention contemplate any and all such arrangements.

In the example shown in FIG. 7, memory 708 may include dentition data measurement routines 712, 3D CAD teeth model construction routines 714, 3D CAD teeth model editing routines 716, CCAA design routines 718, manufacturing control data generation routines 720, and operating system 722. Dentition data measurement routines 712 may obtain and process dentition data, such as may be generated by CT layer scanning or a non-contact 3D scanner directly on the patient's teeth, or uses 3D readings on the teeth model previously cast 3D CAD teeth model construction routines 714 may construct a 3D CAD model of the measured teeth based on the dentition data. 3D CAD teeth model editing routines 716 may be used to re-arrange the teeth in the model to the desired treatment outcomes and may additionally be used to accept additional information, such as the desired torque, offset, angulation of select CCAAs and occlusal/incisal coverage for placement guide. CCAA design routines 718 may be used to design and generate a 3D CAD model based on the input 3D CAD model of the measured teeth, the model of the desired treatment outcomes, and the input additional information. Manufacturing control data generation routines 720 may be used to generate manufacturing control data for use by the production equipment. Operating system 722 provides overall system functionality.

As shown in FIG. 7, an embodiment of the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

It is important to note that while aspects of the present invention may be implemented in the context of a fully functioning data processing system, those of ordinary skill in the art will appreciate that the processes of an embodiment of the present invention are capable of being distributed in the form of a computer program product including a computer readable medium of instructions. Examples of non-transitory computer readable media include storage media, examples of which include, but are not limited to, floppy disks, hard disk drives, CD-ROMs, DVD-ROMs, RAM, and, flash memory.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1-22. (canceled)

23. A method of manufacturing a clear aligner attachment tube by additive manufacturing, the method comprising:
obtaining a three-dimensional (3D) model of one or more teeth of a patient;
generating a 3D model of an attachment tube using the 3D model of the one or more teeth of the patient, wherein the 3D model of the attachment tube is configured:
for use with a clear aligner to move the patient's teeth; and
to receive a portion of an archwire to move the patient's teeth without the clear aligner; and
using an additive manufacturing device to produce the attachment tube based on the 3D model of the attachment tube.

24. The method of claim 23, wherein the attachment tube comprises a channel.

25. The method of claim 24, wherein the channel comprises a slot.

26. The method of claim 25, wherein the slot is a curved slot.

27. The method of claim 24, wherein the channel comprises a circular cross-section.

28. The method of claim 24, wherein the channel comprises a rectangular cross section.

29. The method of claim 28, wherein the rectangular cross section comprises rounded corners.

30. The method of claim 24, wherein the channel comprises a square cross section.

31. The method of claim 30, wherein the square cross section comprises rounded corners.

32. The method of claim 23, wherein the attachment tube comprises a cross-section of no more than 0.50 mm².

33. The method of claim 23, further comprising:
a base for attachment to a tooth of the patient, wherein the base comprises four edges around a surface of the base, comprising:
a first edge and a second edge opposite the first edge; and
a third edge and a fourth edge opposite the third edge.

34. The method of claim 33, further comprising:
a first surface that extends upwards from the first edge of the base to a first top of the first surface; and
a second surface that extends upwards from the second edge of the base to a second top of the second surface.

35. The method of claim 34, wherein the first top of the first surface extends further than the second top of the second surface.

36. The method of claim 35, wherein the attachment tube comprises a trapezoidal cross section.

37. The method of claim 34, further comprising a third surface, wherein the third surface is opposite the base.

38. The method of claim 37, wherein the third surface and the base comprise a first curvature.

39. The method of claim 35, wherein the first surface and the second surface comprise a second curvature.

40. The method of claim 33, wherein:
the base comprises a plurality of retentive structures configured to oppose a surface of the tooth; and
adjacent retentive structures of the plurality are separated by a corresponding recess.

41. An attachment tube manufactured by additive manufacturing using a 3D model of the attachment tube, the attachment tube comprising:
a channel configured to receive a portion of an archwire,
wherein the attachment tube is configured:
for use with a clear aligner to move the patient's teeth; and
to receive the portion of the archwire to move the patient's teeth without the clear aligner.

42. At least one non-transitory computer-readable storage medium encoded with a plurality of computer-executable instructions that, when executed by one or more processors, are operable to cause the one or more processors to perform a method for manufacturing a clear aligner attachment tube by additive manufacturing, the method comprising:
obtaining a three-dimensional (3D) model of one or more teeth of a patient;
generating a 3D model of an attachment tube using the 3D model of the one or more teeth of the patient, wherein the 3D model of the attachment tube is configured:
for use with a clear aligner to move the patient's teeth; and
to receive a portion of an archwire to move the patient's teeth without the clear aligner; and
using an additive manufacturing device to produce the attachment tube based on the 3D model of the attachment tube.
